(19) United States
(12) Patent Application Publication
(10) Pub. No.: US 2026/0009369 A1
(43) Pub. Date: Jan. 8, 2026

(54) GUIDE VANE

(71) Applicant: ANDRITZ HYDRO GmbH, Wien (AT)

(72) Inventor: Markus OSWALD, Marchtrenk (AT)

(73) Assignee: ANDRITZ HYDRO GmbH, Wien (AT)

(21) Appl. No.: 19/104,829

(22) PCT Filed: Jun. 21, 2023
(86) PCT No.: PCT/AT2023/060193

§ 371 Date: Feb. 19, 2025

(30) Foreign Application Priority Data
Sep. 7, 2022 (AT) A 50680/2022

(51) Int. Cl. F03B 3/18

(52) U.S. Cl. CPC F03B 3/18

(57) ABSTRACT

A guide vane for a guide wheel of a pump or turbine and method for designing the guide vane. The guide vane includes, a guide vane body having a leading edge, a trailing edge, a chord, and at least one pivot pin. The guide vane can be mounted to be rotated about a rotation axis defined by the pivot pin. In order to achieve a particularly high efficiency, the chord is, at least in some regions, spaced apart from the rotation axis and/or the guide vane body includes, at least in some regions, a surface formed by a freeform surface.

The invention relates to a guide vane for a guide wheel of a pump or turbine, comprising a guide vane body having a leading edge, a trailing edge, a chord, and at least one, preferably two, pivot pins, wherein the guide vane can be mounted such that it can be rotated about a rotation axis that is defined by the pivot pin.

Guide vanes have become known from the prior art, in particular for guiding a working medium onto rotor blades of a runner at an optimal angle in turbines. In contrast to the rotor blades that can be rotated with the runner, the guide vanes are, as a rule, arranged to be stationary, but can be rotated in an inlet housing in order to influence a flow and, if necessary, prevent a mass flow. For this purpose, for example in Kaplan or Francis turbines, the guide vanes can normally be arranged in the inlet housing along a circle coaxial with the runner, whereby what is referred to as a guide apparatus results, which is also called a guide ring.

Guide vanes known from the prior art are mounted in the guide apparatus using one or two pivot pins. so that there results a rotation axis about which the guide vanes can be rotated. These guide vanes comprise a guide vane body with a flow profile that is essentially constant along an axial extension, for example an NACA profile. Additionally, guide vanes with flow profiles that differ over an axial extension have become known, which is also known as a profiled strake, or as a straked guide vane. A skeleton curve end angle can thereby be varied along an axial extension of the guide vane, for example.

In addition, methods for designing guide vanes for hydroelectric power plants have also become known from the prior art. According to the prior art, a flow profile is thereby typically chosen and, if necessary, minor changes to said flow profile are made, such as a strake in particular, in order to determine a most favorable possible design of the guide vane.

It has been shown, however, that in many cases a merely unsatisfactorily high level of efficiency is achieved using guide vanes known from the prior art, which is why there is a need for guide vanes with which a higher level of efficiency can be achieved.

This is addressed by the invention. The object of the invention is to specify a guide vane of the type named at the outset with which a particularly high level of efficiency can be achieved when used in a hydroelectric power plant.

This object is attained according to the invention by a guide vane of the type named at the outset in which the chord of the guide vane is, at least in some regions, spaced apart from the rotation axis and/or the guide vane body comprises, at least in some regions, a surface formed by a freeform surface.

In the course of the invention, it was found on the one hand that a beneficial influence of flow is possible with a guide vane body arranged to be eccentric from the rotation axis, on which guide vane body the chord of the guide vane is spaced apart from the rotation axis in at least some regions, preferably along an entire axial extension of the guide vane. Thus, particularly during refurbishment of existing hydroelectric power plants in which positions of the pivot pins or positions of the rotation axes of the guide vanes can no longer be altered. spacing between the guide vanes and the rotor blades can be altered by means of eccentrically arranged guide vane bodies. In particular through a reduction of a spacing between the guide vanes and the rotor blades, that is, a shift of the guide vanes radially inwardly, and thus towards the machine axis, a favorable influence of flow can often be achieved, which leads to an increase in the level of efficiency.

On the other hand, it was found in the course of the invention that particularly favorable flow characteristics can be achieved with a guide vane body which, at least in some regions, comprises a surface formed by a freeform surface. The reason is that conventional guide vanes, which normally have a flow profile that is constant along an axial extension, if necessary with a strake, cause local turbulences due to boundary layer effects, in particular in edge regions, which turbulences result in unfavorable levels of efficiency. With the use of a freeform surface for the guide vane, there is in particular no limitation to a single flow profile, so that the guide vane can, for example. accordingly be embodied differently at the axial ends, where boundary layer effects play a role, than at an axial center region, in which boundary layer effects are no longer present.

A better level of efficiency can be achieved using both only an eccentric guide vane and only a guide vane comprising a freeform surface, although it is preferably provided that both features are implemented in order to achieve a particularly high level of efficiency.

It is particularly preferable if it is provided that the rotation axis is positioned, at least in some regions, preferably along an entire axial extension of the guide vane body, outside of the guide vane body. In this case, an extension along the rotation axis defined by the pivot pin is considered to be the axial extension. The direction along the chord that is defined by a direct connection of the leading edge and trailing edge is considered to be the longitudinal direction. A thickness of the flow profile, or a profile width, is defined along a transverse direction in a plane perpendicular to the axial direction, or perpendicular to the axial extension, and perpendicular to the longitudinal direction.

It is particularly beneficial if the rotation axis has, at least in some regions, preferably along an entire axial extension of the guide vane body, a spacing from the guide vane body which corresponds to at least 50%, preferably at least 75%, of a maximum thickness of the guide vane. This enables a good movement of the guide vanes closer to the rotor blades, in order to obtain a short flow path between the guide vanes and the rotor blades, which has proven to be beneficial in terms of fluid mechanics.

It has proven effective that the chords comprise, at least in a partial region of the guide vane, preferably along an entire axial extension of the guide vane body, a spacing from the rotation axis that corresponds to at least 15%, preferably at least 30%. of a length of the chords.

Here, the portion of the guide vane having a flow profile is considered to be the guide vane body, around which portion a fluid flows when the guide vane is used as intended in a guide ring or guide apparatus of a hydroelectric power plant. It shall be understood that, in a linkage to the pivot pins, the guide van body can be embodied with a rounding or the like at the ends, wherein a smaller spacing between the guide vane body and the rotation axis can, of course, then be provided in the region of said rounding. In addition, it can also be provided that the guide vane body no longer has any spacing from the rotation axis in the region of the rounding at the ends.

A spacing of the chord from the rotation axis can also be stated relatively in relation to a length of the chord. Here, it has proven effective if the chord has, at least in a partial region of the guide vane, preferably along an entire axial extension of the guide vane body, a spacing from the rotation axis that corresponds to at least 25%, preferably at least 30%, of a length of the chord. A guide vane embodiment of this type has proven particularly advantageous for an application on a Francis turbine.

It is beneficial if the chord comprises, at least in a partial region of the guide vane, preferably along an entire axial extension of the guide vane body, a spacing from the rotation axis that corresponds to at least 50%, preferably at least 75%, of a maximum thickness of the guide vane.

It has been shown that, especially in a region of the leading edge, boundary layer effects have a comparatively large influence on the level of efficiency. In this regard, it has therefore proven beneficial if the guide vane body forms different flow profiles along an axial extension, which flow profiles differ at the leading edge. The leading edge can thus be embodied to be respectively optimized according to the local flow conditions along the axial direction or along the axial extension of the guide vane so that flow profiles which are adapted to the boundary layers in an edge region or at the ends, for example, can be provided.

It is beneficial if the flow profiles at the leading edge have at the axial ends a greater thickness than in a region therebetween. It has been shown that an advantageous influence on flow is thereby enabled.

It is preferably provided that the flow profiles at the leading edge have at the axial ends chords which are longer than chords of flow profiles therebetween, so that end noses are formed at the leading edge. As a result of these end noses on the leading edge, an inflow can be positively influenced, whereby a higher level of efficiency is achieved.

It is particularly preferred if it is provided that the chords of the end flow profiles at the leading edge are at an angle to chords of flow profiles therebetween. It has been shown, for example, that, due to boundary layer effects, different flow conditions can prevail at an axial end and an axial beginning of the guide vane, which flow conditions lead to turbulences and a reduction of the efficiency level in the case of a guide vane that is constant along the axial extension, which is why differently pitched chords at the beginning and at the end of the guide vane can be very favorable for the level of efficiency. It shall be understood that the pitch of the chord at the axial end and at the axial beginning typically results from the flow in said region or from the effect of boundary layers, which can in particular be determined using a flow simulation. Accordingly, a skeleton line can also be sloped differently at axial end regions than in axial center regions of the guide vane, in particular at the leading edge.

It can also be beneficial if, along an axial extension, the guide vane body forms different flow profiles that differ at the trailing edge. It is thus also possible at the trailing edge to adapt the flow profile of the guide vane body to boundary layer effects, for example.

In addition, the guide vane can then also be embodied to be wide enough in the region of the trailing edge that sufficient room remains for a gasket on the face of the guide vane.

It is particularly beneficial if flow profiles in a region that is close to the trailing edge have a greater thickness at the axial ends than in a region therebetween, so that a thickening forms. This enables a good positioning of a gasket on the face of the guide vane body close to the trailing edge, whereby losses in efficiency level due to flows around the guide vanes at the axial ends are reduced. A region which is spaced apart from the trailing edge by less than 30%, in particular less than 20%, preferably less than 10%, particularly preferably less than 5%, of a length of the skeleton line can be understood as a region that is positioned close to the trailing edge. The thickening can project all the way to the trailing edge, but can also end before the trailing edge, for example with a spacing of 1% to 10% of the skeleton line length from the trailing edge, so that the trailing edge itself has no thickening. This enables a particularly good facial sealing of the guide vane body.

The thickening can be provided at one axial end of the guide vane or at both axial ends, in order to enable a particularly good sealing at the corresponding face.

It is preferably provided that gaskets are arranged on faces of the guide vane body. Typically, these gaskets are positioned in grooves which are arranged on faces. These gaskets seal a flow channel against boundary surfaces in the guide apparatus. The grooves and gaskets can extend all the way into the region of the thickenings, in particular over the entire length of the thickenings, in order to achieve a most effective sealing possible.

It has proven effective that the pivot pins comprise an end face which is embodied to be roughly perpendicular to the rotation axis and at which the pivot pins are connected to the guide vane body. Such an embodiment of a guide vane is also referred to as a plate design, since the ends of the pivot pins are perpendicular to the rotation axis and are embodied to be roughly plate-shaped.

It is beneficial if a rounding is arranged at a transition region between the guide vane body and end face, wherein the rounding has different curvature radii along a longitudinal direction of the guide vane. As a result, favorable flow characteristics are obtained which contribute to an advantageous efficiency level. Through the use of different curvature radii along the longitudinal direction at the rounding, it is also possible to regard local flow conditions here, which can be determined in a flow simulation, for example. In principle, a small curvature radius is beneficial in order to achieve a large cross section for the fluid flowing through, but a larger curvature radius can be necessary in individual regions in order to satisfy requirements in terms of strength or rigidity, for example.

Through the use of different curvature radii along the longitudinal direction of the guide vane, both goals can be achieved.

In particular, it can be provided that a curvature radius along the longitudinal direction of the guide vane initially becomes larger, then becomes smaller, and finally becomes larger again. Furthermore, it can be provided that the rounding has one or more inflection points along the longitudinal direction.

It has proven effective that the guide vane body comprises at the axial ends roundings which extend from the leading edge to the trailing edge, in particular concave roundings. The roundings can thus extend beyond the pivot pins in a longitudinal direction. As a result, sharp corners in the flow profile are avoided, which could otherwise arise at a contact surface between the guide vane body and a surrounding wall.

In the case of a guide wheel for a pump or turbine, in particular for a Kaplan or Francis turbine, which is formed by multiple guide vanes, it is preferred if the guide vanes are embodied according to the invention.

It is beneficial if the vane bodies of the guide vanes are arranged to be eccentric from the rotation axes of the respective guide vanes such that the chords of the vane bodies have a smaller spacing from the machine axis than the rotation axes.

Additional features, advantages, and effects of the invention follow from the exemplary embodiment described below. In the drawings which are thereby referenced:

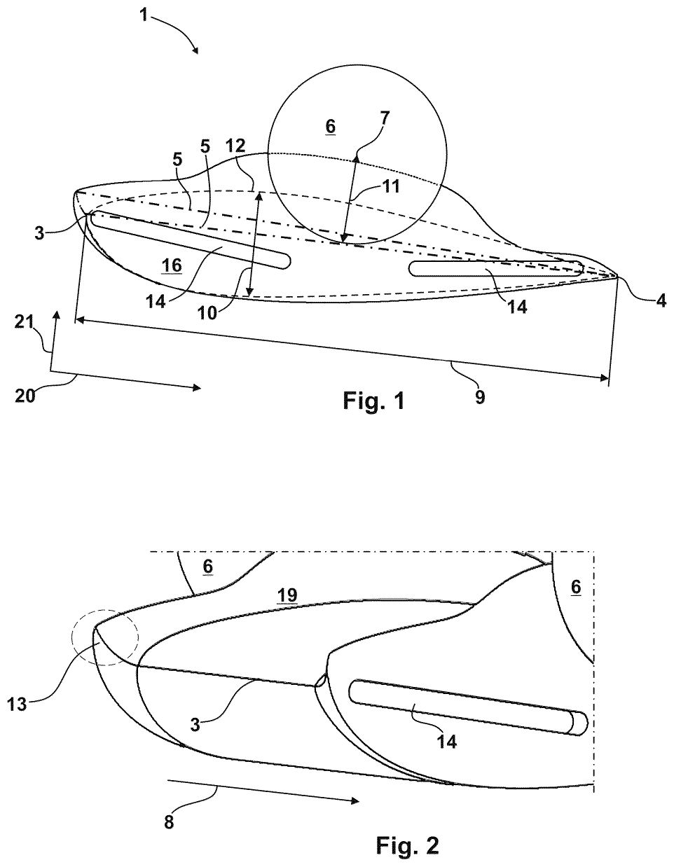

FIGS. 1 through 6 show a guide vane embodied according to the invention in different views;

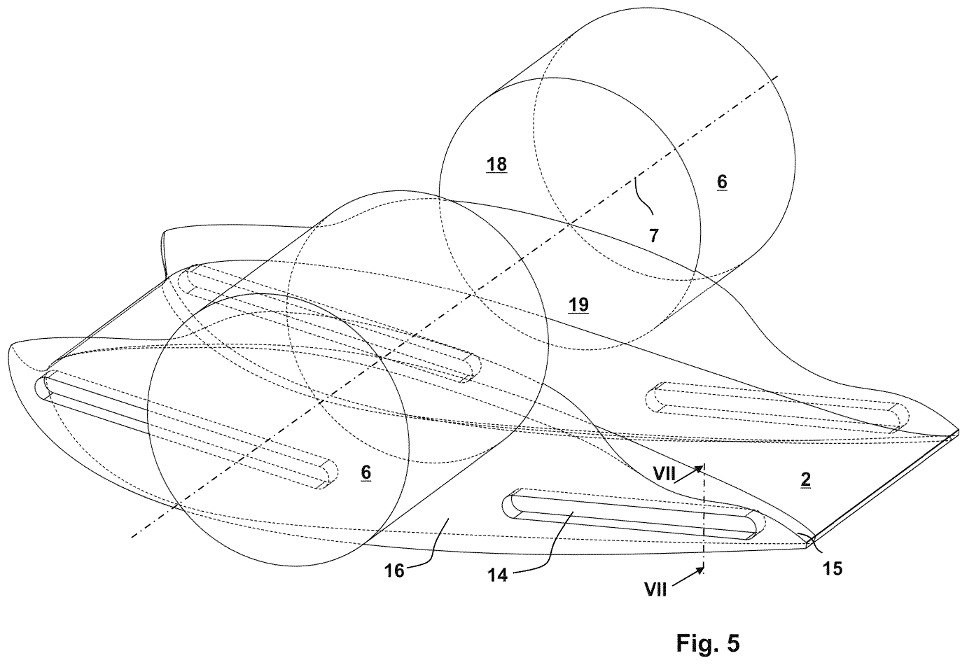

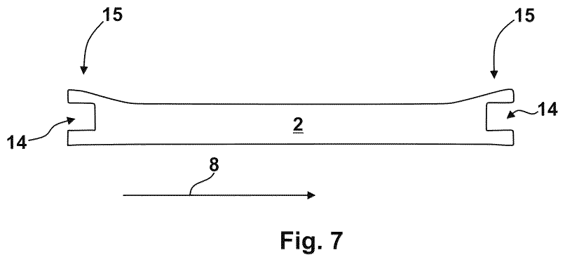

FIG. 7 shows a section through the guide vane illustrated in FIG. 5 along the line VII-VII.

FIGS. 1 through 6 show a guide vane 1 according to the invention in different views, wherein FIG. 1 shows a view with a line of sight along a rotation axis 7, about which rotation axis 7 the guide vane 1 can be rotatably arranged in a guide apparatus, and which rotation axis 7 is defined by two pivot pins 6 attached to a guide vane body 2 on the faces. It shall be understood that an embodiment in which only one pivot pin 6 is provided and the rotation axis 7 is defined by only one pivot pin 6 is also possible.

In this case, the guide vane body 2 does not have a constant flow profile 12 along the axial direction 8. but rather individual regions of the guide vane body 2 along the axial direction & are respectively adapted to the flow in an optimized manner in terms of flow mechanics, wherein boundary layer effects at the axial beginning and axial end, for example, are taken into account by a modified shape of the flow profile 12 in said regions. This complex shape of the surface is referred to here as a freeform surface, especially since the surface cannot simply be formed by extruding a flow profile 12 along the axial direction 8.

As can be seen in FIG. 1. the guide vane body 2 is arranged to be eccentric from the rotation axis 7 or is spaced apart from the rotation axis 7. A spacing 11 of a chord 5 which forms a connection of a leading edge 3 to a trailing edge 4 of the guide vane body 2 is in this case more than 25% of a length 9 of the chord 5 or of a length 9 of the guide vane 1.

Between the leading edge 3 and trailing edge 4. the guide vane body 2 forms a flow profile 12, wherein the flow profile 12 changes along an axial direction 8 so that sections perpendicular to the axial direction 8 have different flow profiles 12. For the purpose of illustration, chords 5 of two different flow profiles 12 are illustrated in FIG. 1, wherein chords 5 of a flow profile 12 in an axial end region and of a flow profile 12 in an axial center region are illustrated, which chords 5 are at an angle to one another, as depicted. In the exemplary embodiment illustrated, the chords 5 intersect at the trailing edge 4, even though an embodiment would, in principle, also be possible in which the flow profiles 12 in an axial end region also differ at the trailing edge 4 from flow profiles 12 in an axial center region, so that the position of the trailing edge 4 varies along the axial direction 8, or the trailing edge 4 does not run parallel to the axial direction 8.

In the exemplary embodiment illustrated, a spacing 11 of the chord 5 from the rotation axis 7 corresponds roughly to 1.2 times a maximum thickness 10 of the profile in a transverse direction 21 that is oriented perpendicularly to the longitudinal direction 20 and perpendicularly to the rotation axis 7 or to the axial direction 8. The spacing 11 can also be stated in relation to the length 9 of the chord 5, wherein the spacing 11 in this case corresponds to roughly 20% of a length 9 of the chord 5. As can be seen, a flow profile 12 of the guide vane body 2, and therefore also the guide vane body 2 itself, is also spaced apart from the rotation axis 7 in a center region.

As a result of this eccentric arrangement of the guide vane 1 relative to the rotation axis 7, a small distance from the guide vane 1 to rotor blades of a runner can be achieved, whereby a flow path between the guide vane 1 and rotor blade is short and turbulences between the guide vanes 1 and the rotor blades are thus reduced, whereby a high efficiency is achieved.

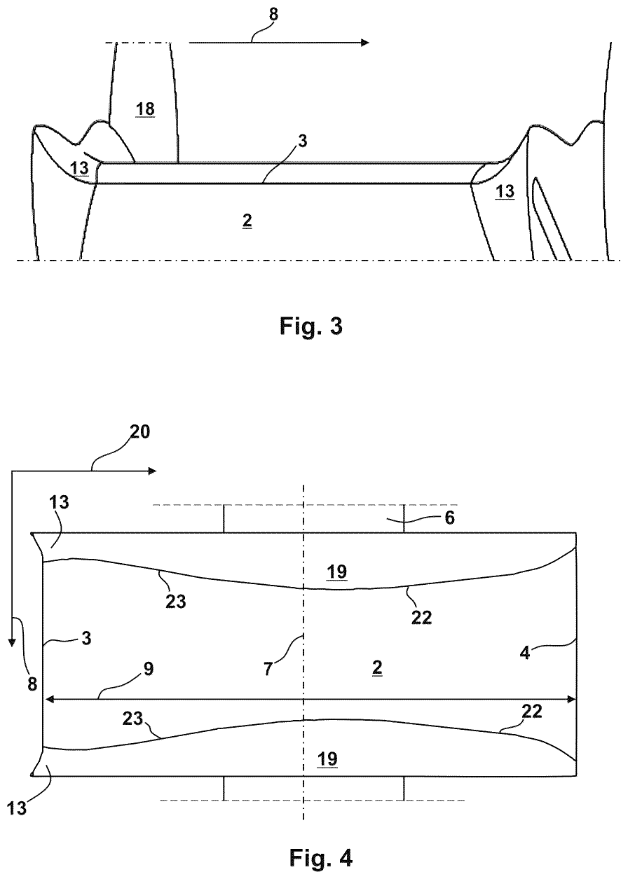

FIGS. 2 and 3 show the leading edge 3 of the guide vane I in detail. As can be seen, the guide vane 1 comprises at a beginning and an end, each viewed in the axial direction 8, noses 13 which extend farther in the longitudinal direction 20 than the leading edge 3 in a region between the beginning and end. The reason is that, as a result of the corresponding noses 13, a design of the guide vanes I or of the guide vane bodies 2 at the axial beginning and at the axial end can be achieved, with which design flow conditions present in a corresponding boundary layer can be accommodated. A flow profile 12 of the guide vane body 2 thus changes along the axial extension, and, in the region of the leading edge 3. a skeleton line is oriented differently at the axial beginning and end than therebetween, in order to be able to accommodate the flow particularly well in said region.

As follows from FIG. 3, the leading edge 3 is, viewed in the transverse direction 21, thus embodied to be roughly U-shaped, or forms noses 13 at the ends, to optimize flow.

FIG. 4 shows a side view of the guide vane 1. In addition to the noses 13 at the leading edge 3, a transition 22 from a rounding 19 to the guide vane body 2 is visible here. Said transition 22 is determined by flow simulations and has different curvatures over a longitudinal direction 20 of the guide vane 1, whereby it is possible to regard local flow conditions particularly well, in order to achieve a very high level of efficiency. It can be seen in FIG. 4 in particular that the transition 22 of the rounding 19 to that portion of the guide vane body 2 which has an approximately constant cross section in the axial direction comprises an inflection point 23 in a front third of the guide vane 1.

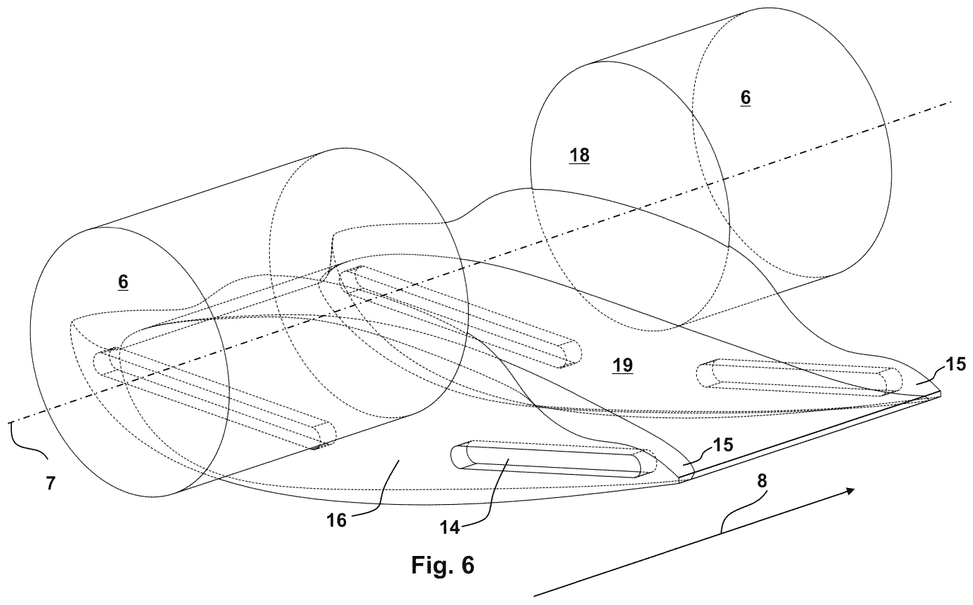

FIGS. 5 and 6 show further views of the guide vane 1, wherein the trailing edge 4 can easily be seen. As can easily be recognized here, the guide vane body 2 also has at the trailing edge 4 a cross section that is not continuous, or is varying, along the axial direction, so that a thickness 10 of the profile at the axial beginning and at the axial end is larger than between said regions. As a result, more space remains on faces 16 of the guide vane body 2 for a groove 14 in which a gasket 17 can be arranged.

FIGS. 5 and 6 furthermore show the plate design of the guide vane 1, wherein the pivot pins 6 have end faces 18 which are oriented roughly perpendicularly to the rotation axis 7. Between the end faces 18 of the pivot pins 6 and the guide vane bodies 2, a rounding 19 is arranged which has different curvatures along the longitudinal direction 20 of the guide vane 1 and extends from the leading edge 3 to the trailing edge 4, that is, past the pivot pin 6 or the plate.

FIG. 7 shows a section through the guide vane body 2 along the line VII-VII in FIG. 5 in an illustration not to scale. Here, the thickening 15 at the axial ends can be very easily recognized, which thickening 15 makes possible the groove 14 on the face all the way into a region close to the trailing edge 4, so that a flow on the face is prevented almost all the way to the trailing edge 4, whereby a particularly high level of efficiency is obtained. As can easily be seen, a groove 14 would no longer be possible in this region near the trailing edge 4 without the thickening 15.

With a guide vane I according to the invention, a particularly favorable flow can be achieved in the usage in a hydroelectric power plant, which flow results in a high level of efficiency.

1. A guide vane for a guide wheel of a pump or turbine, comprising a guide vane body having a leading edge, a trailing edge, a chord, and at least one pivot pin, wherein the guide vane can be mounted such that it can be rotated about a rotation axis that is defined by the pivot pin, wherein the chord of the guide vane is, at least in some regions, spaced apart from the rotation axis, wherein the guide vane body forms different flow profiles along an axial extension, which flow profiles differ at the leading edge and/or at the trailing edge, and wherein the rotation axis is positioned, at least in some regions, outside of the guide vane body.

2. The guide vane according to claim 1, wherein the rotation axis is positioned outside of the guide vane body along an entire axial extension of the guide vane body.

3. The guide vane according to claim 1, wherein the rotation axis has, at least in some regions, preferably along an entire axial extension of the guide vane body, a spacing from the guide vane body which corresponds to at least 50%, preferably at least 75%, of a maximum thickness of the guide vane.

4. The guide vane according to claim 1, wherein the chord comprises, at least in a partial region of the guide vane, preferably along an entire axial extension of the guide vane body, a spacing from the rotation axis that corresponds to at least 15%, preferably at least 30%, of a length of the chord.

5. The guide vane according to claim 1, wherein the chord comprises, at least in a partial region of the guide vane, preferably along an entire axial extension of the guide vane body, a spacing from the rotation axis that corresponds to at least 50%, preferably at least 75%, of a maximum thickness of the guide vane.

6. (canceled)

7. The guide vane according to claim 1, wherein the flow profiles at the leading edge have at the axial ends a greater thickness than in a region therebetween.

8. The guide vane according to claim 1, wherein the flow profiles at the leading edge have at the axial ends chords which are longer than chords of flow profiles therebetween, so that end noses are formed at the leading edge.

9. The guide vane according to claim 1, wherein the chords of the end flow profiles at the leading edge are at an angle to chords of flow profiles therebetween.

10. (canceled)

11. The guide vane according to claim 1, wherein flow profiles in a region that is close to the trailing edge have a greater thickness at the axial ends than in a region therebetween, so that a thickening forms.

12. The guide vane according to claim 1, wherein gaskets are arranged on faces of the guide vane body.

13. The guide vane according to claim 1. wherein the pivot pins comprise an end face which is embodied to be roughly perpendicular to the rotation axis and at which the pivot pins are connected to the guide vane body.

14. The guide vane according to claim 13, wherein a rounding is arranged at a transition region between the guide vane body and end face, wherein the rounding has different curvature radii along a longitudinal direction of the guide vane.

15. The guide vane according to claim 1, wherein the guide vane body comprises at the axial ends roundings which extend from the leading edge to the trailing edge.

16. A guide wheel for a pump or turbine, in particular for a Kaplan or Francis turbine, which is formed by multiple guide vanes, wherein the guide vanes are embodied according to claim 1.

17. The guide wheel according to claim 16, wherein the vane bodies of the guide vanes are arranged to be eccentric from the rotation axes of the respective guide vanes such that the chords of the vane bodies have a smaller spacing from the machine axis than the rotation axes.
